(19) United States
(12) Patent Application Publication
(10) Pub. No.: US 2004/0148518 A1
(43) Pub. Date: Jul. 29, 2004

(54) Distributed surveillance system

(76) Inventors: John Grundback, Vasterhaninge (SE); Salil Pradhan, Santa Clara, CA (US); Geoff M. Lyon, Menlo Park, CA (US)

Correspondence Address: HEWLETT-PACKARD COMPANY, Intellectual Property Administration, P.O. Box 272400, Fort Collins, CO, 80527-2400, US

(21) Appl. No.: 10/351,428

(22) Filed: Jan. 27, 2003

(51) Int. Cl. H04L 9/00

(52) U.S. Cl. 713/201; 713/176

(57) ABSTRACT

A distributed surveillance system comprises a plurality of nodes including sensors for monitoring areas, and a network connecting the plurality of nodes. A node is operable to detect an object in one of the monitoring areas and transmit a tracking message to other nodes in the system via the network. The tracking message identifies the detected object.

### FIELD OF THE INVENTION

The invention relates to surveillance systems. More particularly, the invention relates to distributed surveillance systems.

### BACKGROUND OF THE INVENTION

Given the increasing threat of crime, terrorism and violence, security and surveillance is becoming of paramount importance. As a result, the demand for security systems has likely increased. Known security systems typically utilize one or more sensors connected to a remote central location for monitoring a predefined area. These security systems, although widely used, have limited fault tolerance. For example, if a central monitoring system becomes inoperative, typically the entire system becomes inoperative. Also, setup costs for these system are generally high.

### SUMMARY OF THE INVENTION

According to an embodiment of the invention, a method for tracking an object in a distributed surveillance system comprises detecting an object in a monitoring area for a node; determining at least one signature for the object; and transmitting a tracking message to at least one other node, the tracking message including the at least one signature for the object.

According to another embodiment of the invention, a method for tracking an object in a distributed surveillance system comprises detecting an object in a monitoring area; determining at least one signature for the object; determining whether the at least one signature corresponds to an object previously detected by a node of a plurality of nodes; and transmitting a tracking message to at least one node of the plurality of nodes in response to determining the at least one signature corresponds to the object previously detected, wherein the tracking message includes the at least one signature for the object.

According to yet another embodiment of the invention, an apparatus comprises means for detecting an object in a monitoring area for a node of a plurality of nodes; means for determining at least one signature for the object; and means for transmitting a tracking message to at least one other node of the plurality of nodes, the tracking message including the at least one signature for the object.

According to yet another embodiment of the invention, an apparatus comprises means for detecting an object in a monitoring area; means for determining at least one signature for the object; means for determining whether the at least one signature corresponds to an object previously detected by a node of the plurality of nodes; and means for transmitting a tracking message to at least one node of the plurality of nodes in response to determining the at least one signature corresponds to the object previously detected, the tracking message including the at least one signature for the object.

According to yet another embodiment of the invention, a distributed surveillance system comprises a plurality of nodes including sensors for monitoring areas and a network connecting the plurality of nodes. A node of the plurality of nodes is operable to detect an object in one of the monitoring areas and transmit a tracking message to other nodes via the network, wherein the tracking message identifies the detected object.

According to yet another embodiment of the invention, a node in a distributed surveillance system comprises at least one sensor operable to detect an object; a processor operable to determine a signature for the object and generate a tracking message including the signature; and a transmitter operable to transmit the tracking message to other nodes in the system.

### BRIEF DESCRIPTION OF THE DRAWINGS

The present invention is illustrated by way of example and not limitation in the accompanying figures in which like numeral references refer to like elements, and wherein:

FIG. 1 illustrates a block diagram of a surveillance system, according to an embodiment of the invention;

FIG. 2 illustrates an example of tracking an object, according to an embodiment of the invention;

FIG. 3 illustrates another example of tracking an object, according to an embodiment of the invention;

FIG. 4 illustrates a flow diagram of a method performed by an active node, according an embodiment of the invention;

FIG. 5 illustrates a flow diagram of a method performed by a passive node, according an embodiment of the invention; and

FIG. 6 illustrates a block diagram of a node platform, according to an embodiment of the invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well-known structures, interfaces, and processes have not been shown in detail in order not to unnecessarily obscure the present invention.

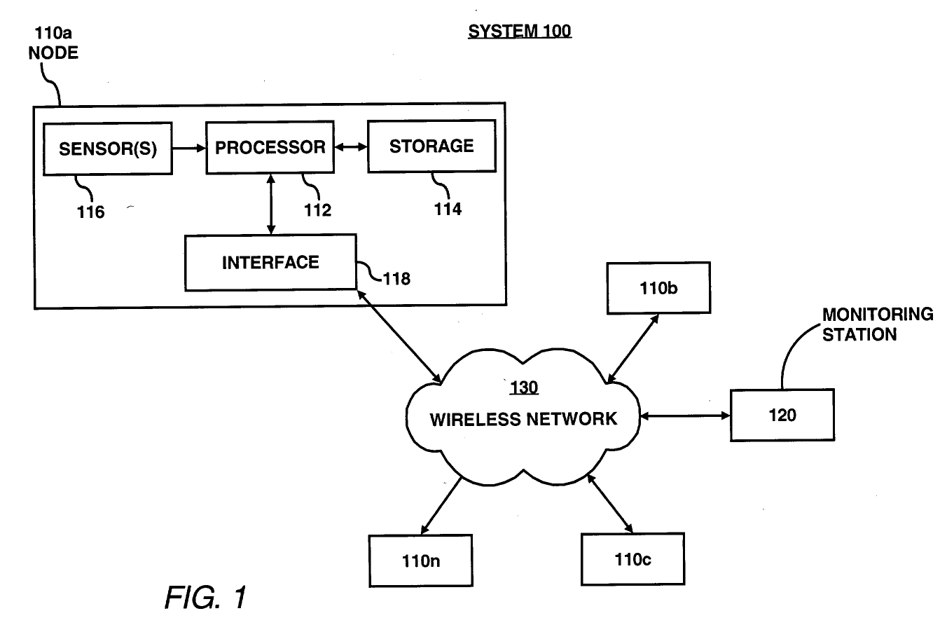

FIG. 1 illustrates a surveillance system 100 according to an embodiment of the invention. Nodes 110a . . . n are connected via a wireless network 130 for transmitting messages, such as tracking messages, amongst each other. Each of the nodes 110a . . . n is operable to monitor an area using one or more sensors for detecting an event. An event may include an object (e.g., human, animal, apparatus, etc.) entering the monitored area. The nodes 110a . . . n transmit tracking messages including information associated with tracked objects. Unlike conventional surveillance systems, the system 100 and the nodes 110a . . . n are not dependent on a central monitoring station. Furthermore, the nodes 110a . . . n are substantially independent, such that if one of the nodes 110a . . . n fails, the system 100 is not inoperative.

Circuits for the node 110a are shown and may be included in each of the other nodes in the system 100. The node 110a includes an interface 118 for communicating messages via the network 130. One or more sensors 116 are used for monitoring an area typically within a proximity to the node 110a. The sensors 116 may include sensors known in the art that are operable to monitor an area using one or more types of mediums (e.g., visual, infrared (IR), acoustic, etc.). A processor 112 may determine a signature for a detected object and store the signature in the storage 114.

A signature is a mathematical description of one or more characteristics of a detected object. The signature is unique to the object and can be used to track the object as it enters different areas being monitored by respective nodes. A signature is also unique to a medium (e.g., visual, IR, acoustic, etc.) by which the associated object is detected. For example, one object can have an acoustic signature and a visual signature. The visual signature may be based on characteristics detected by a camera, and the acoustic signature may be based on characteristics detected by a microphone. Also, a signature may be a combination of different medium characteristics for improved accuracy. Techniques are known in the art for calculating a signature for an object based on detected characteristics. For example, a signature may include a dimensional analysis of facial characteristics from camera images, such as distance between a person's eyes, nose, mouth, chin, etc. Infrared facial pattern recognition may be used to determine a heat signature of a person's face. Also, a signature may use a ratio of body fat/body mass measured by bulk conductivity. These and other techniques may be used for calculating a signature.

A monitoring station 120 may optionally be connected to the wireless network 130. The monitoring station may include a conventional central monitoring station. For example, the monitoring station may include notification means (alarms, monitors, etc.) for notifying a security guard of a tracked object.

The nodes 110a . . . n are operable to determine and transmit respective location information. In one embodiment, the nodes 110a . . . n may be computer-based nodes executing location software for generating a coordinate system. The coordinate system may have greater than two dimensions (e.g., latitude, longitude, and altitude). When a node joins the system 100, the node communicates with one or more of the nodes a . . . n to get its location (i.e., location information) within the coordinate system. This location information may be transmitted with tracking messages, including signature information for an object being tracked.

It will be apparent to one of ordinary skill in the art that the system 100 may be varied without departing from the spirit of the invention. For example, a wired network may be used in addition to or instead of the wireless network 130. Also, the system 100 may be connected to other similar systems via one or more networks for communicating tracking information and the like.

The nodes 110a . . . n can detect and track an object in the system 100. An object is detected when it enters one or more monitoring areas for a node. Each sensor, for example of the sensor(s) 116, has a specific monitor area. The monitoring areas can overlap. A monitoring area can be active or passive. Tracking of an object begins in an active monitoring area and tracking continues in a passive monitoring area.

When an object is first detected in an active monitoring area, the respective node transmits a tracking message including a calculated signature for the object and a location of the node. The tracking message may be transmitted to other nodes in the system 100. The other nodes may include all the other nodes in the system 100 or a subset of all the nodes. The tracking message may include more than one signature if more than one medium is used to detect the object. The signature(s) are stored at each node receiving the tracking message and in the active node.

If the object enters a passive monitoring area of a node that received the tracking message, the node recognizes the signature of the object. The node then transmits another tracking message including the signature(s) and the location of the node recognizing the signature. This procedure is repeated for each node detecting the object and recognizing the signature(s).

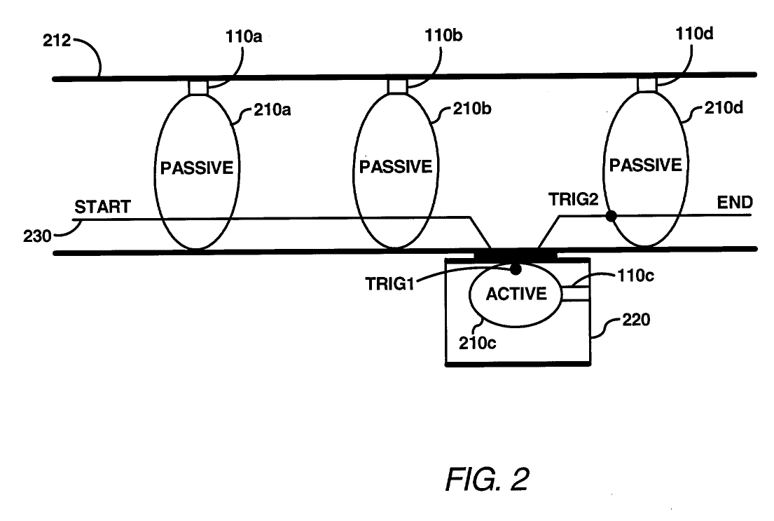

FIG. 2 illustrates an example of tracking an object using nodes, for example, in the system 100. A corridor 212 (e.g., in a building) is shown with a room 220 having an opening to the corridor 210. An object, such as a person, moves along the path 230, for example, after business hours. The person first enters monitoring areas 210a and 210b monitored by sensors for the nodes 110a and 110b, respectively. The monitoring areas 110a and 110b are passive, so no triggering event occurs and the person is not tracked.

The person enters the room 220 including an active monitoring area 210c monitored by a sensor for the node 110c. The person enters the active monitoring area 210c (i.e., a triggering event occurs (TRIG1)), and the node 110c calculates a signature for the object. A tracking message is transmitted to nodes 10a, b, d and possibly other nodes, including the signature and a location of the node 110c. The person continues along the path 230 and enters a passive monitoring area 210d for the node 110d (i.e., a second triggering event (TRIG2)). Because the node 110d recognizes the signature of the object, the node 110d transmits a tracking message, including the signature and the location of the node 110d, to the nodes 110a . . . c and possibly other nodes. The path 230 is shown as ending after the monitoring area 210d. However, the person may continue moving. As the person walks down the corridor 212, the nodes surrounding the person will trigger and transmit tracking messages. Thus, the person is tracked as the person moves around the building. Security may be notified of the person's location, for example, through the monitoring station 120. For example, the monitoring station 120 may receive tracking messages and generate notification of the person's position.

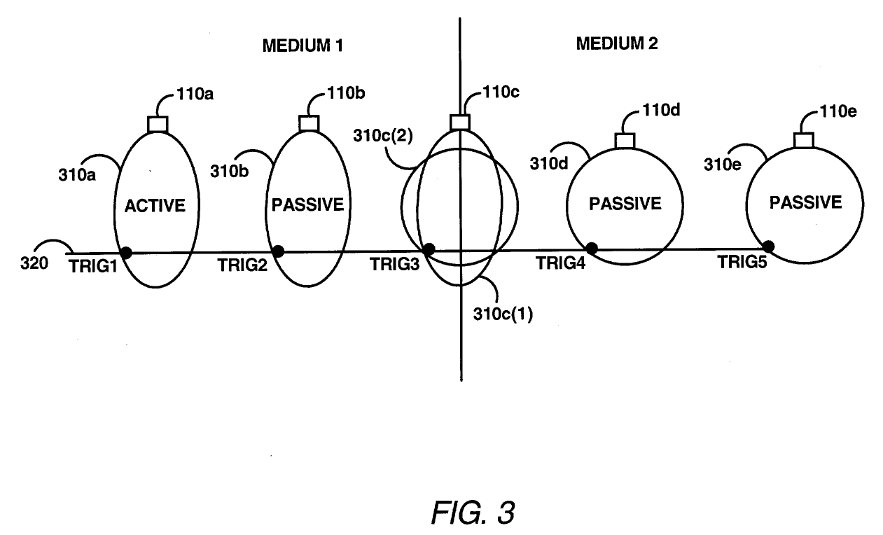

FIG. 3 illustrates another example of tracking an object in the system 100 using at least two tracking mediums. An object moves along the path 320. A first triggering event (TRIG1) occurs as the object enters an active monitoring area 310a monitored by a sensor for the node 110a. The sensor detects objects using a first medium (e.g., IR). A tracking message (e.g., including a signature and location of the node 110a is generated and transmitted to other nodes (e.g., nodes 110b . . . e). The object continues along the path 320 and enters a passive monitoring area 310b for the node 110b (TRIG2). This monitoring area is also monitored using the first medium. A second tracking message is generated and transmitted to other nodes in the system 100.

The node 110c maintains two overlapping monitoring areas 310c(1) and 310c(2). The monitoring area 310c(1) is monitored using the first medium, and the monitoring area 310c(2) is monitored using a second medium (e.g., acoustic). A third triggering event (TRIG3) occurs when the object enters the monitoring area 310c(1). Because the monitoring area 110c(2) overlaps the monitoring area 310c(1), a second signature is calculated using characteristics of the object identified using the second medium even if both monitoring areas 310c(1) and 310c(2) are passive. A tracking message including both signatures and a location of the node 110c is generated and transmitted to the other nodes. Tracking messages are also generated and transmitted by the nodes. 110d and 110e as the object enters monitoring areas 310d and 310e, respectively (TRIG4 and TRIG5). These tracking messages include the second signature and location information for the respective node.

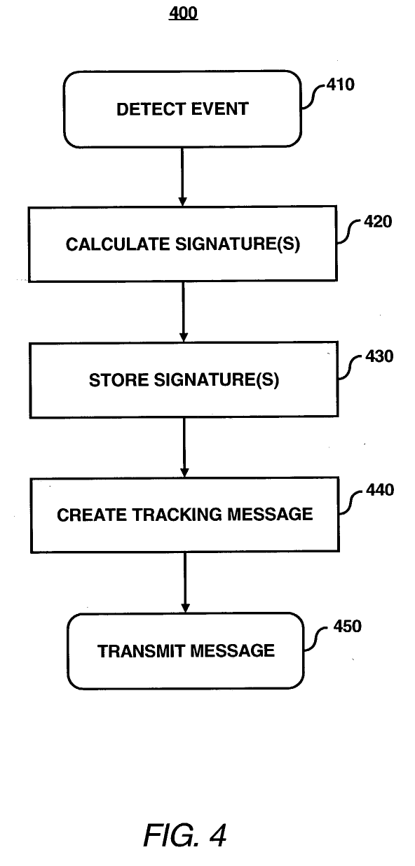

FIG. 4 illustrates a method 400 performed by an active node (e.g., a node having an active monitoring area), according to an embodiment of the invention. In the step 410, an event is detected, such as an object entering a monitoring area. One or more signatures are calculated for the object by the active node (step 420). A signature may be calculated for each medium detecting the object. For example, if an IR sensor and a camera detect the object, an IR signature is calculated (e.g., based on characteristics of the object sensed by the IR sensor) and a visual signature is calculated (e.g., based on characteristics of the object sensed by the camera). In step 430, the calculated signature(s) are stored. A tracking message, including the signature(s) and a location of the active node, is generated (step 440) and transmitted to other nodes in the system (step 450).

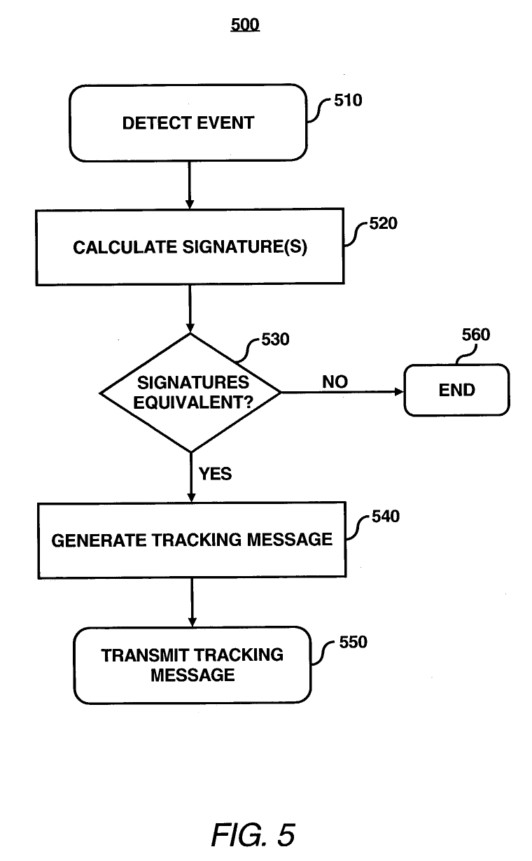

FIG. 5 illustrates a method performed by a passive node (e.g., a node having a passive monitoring area), according to an embodiment of the invention. In step 510, an event is detected by one or more sensors for the passive node maintaining respective passive monitoring areas. The event may include an object entering passive monitoring area(s). Passive monitoring area(s) may include overlapping monitoring areas monitored using different mediums or a single monitoring area.

In step 520, a signature is calculated for each medium. In step 530, the node compares each calculated signature to stored signature(s). For example, signatures previously received in tracking messages are stored in the node and compared to the calculated signature(s). If a calculated signature is substantially equivalent to a stored signature, a tracking message is generated including the calculated signature and a location of the node (step 540). Signatures based on overlapping monitoring areas may also be included in the tracking message. These signatures are also stored in the node. The tracking message is transmitted to other nodes in the system (550). In step 530, if the node determines that a calculated signature is not substantially equivalent to a stored signature, no tracking message is generated (step 560). In step 560, tracking may not begin at a passive node.

The steps of the methods 400 and 500 may be performed by one or more computer programs. The computer programs may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be operable to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

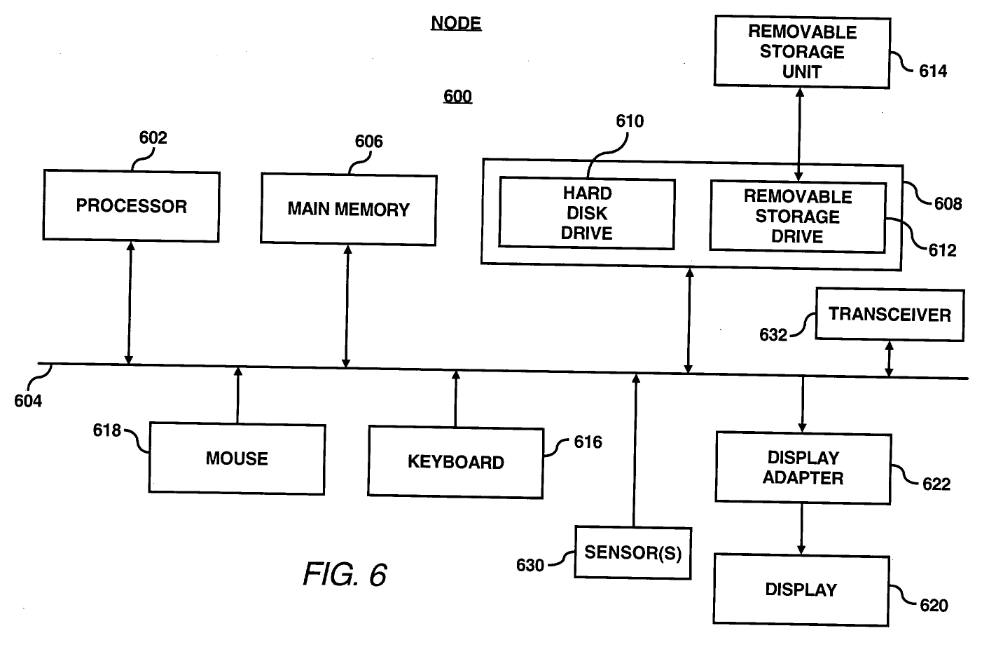

FIG. 6 illustrates an exemplary computer platform 600, according to an embodiment of the invention, for any of the nodes 110a . . . n. The platform includes one or more processors, such as the processor 602, that provide an execution platform for software. The software, for example, may execute one or more of the steps of the methods 400 and/or 500, perform standard operating functions, etc. Commands and data from the processor 602 are communicated over a communication bus 604. The platform 600 also includes a main memory 606, such as a Random Access Memory (RAM), where the software may be executed during runtime, and a secondary memory 608. The secondary memory 608 includes, for example, a hard disk drive 610 and/or a removable storage drive 612, representing a floppy diskette drive, a magnetic tape drive, a compact disk drive, etc., where a copy of a computer program embodiment for the peer privacy module may be stored. The removable storage drive 612 reads from and/or writes to a removable storage unit 614 in a well-known manner. Signatures for detected objects may be stored in the main memory 606 and possibly written to the secondary memory 608. A user interfaces may interface with the platform 600 with a keyboard 616, a mouse 618, and a display 620. The display adaptor 622 interfaces with the communication bus 604 and the display 620 and receives display data from the processor 602 and converts the display data into display commands for the display 620. One or more sensors 630 are included in the platform 600 for detecting objects in a monitoring area. The sensors may include different mediums (e.g., IR, acoustic, visual, etc.). A transceiver 632 may be used to transmit and receive tracking messages.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method for tracking an object in a distributed surveillance system comprising a plurality of nodes, the method comprising steps of:
detecting an object in a monitoring area for a node of the plurality of nodes;
determining at least one signature for the object; and
transmitting a tracking message to at least one other node of the plurality of nodes, the tracking message including the at least one signature for the object.

2. The method of claim 1, further comprising storing the at least one signature.

3. The method of claim 1, wherein the step of detecting an object comprises detecting the object using at least one medium.

4. The method of claim 3, wherein the step of determining at least one signature comprises determining a signature for each medium used to track the object.

5. The method of claim 4, wherein the monitoring area comprises overlapping monitoring areas monitored by a plurality of medium.

6. The method of claim 5, wherein the medium comprises one or more of infrared, acoustic and visual.

7. The method of claim 1, wherein the tracking message includes a location for the node of the plurality of nodes.

8. The method of claim 1, wherein the node of the plurality of nodes is an active node operable to start tracking an object.

9. A method for tracking an object in a distributed surveillance system comprising a plurality of nodes, the method comprising steps of:
detecting an object in a monitoring area;
determining at least one signature for the object;
determining whether the at least one signature corresponds to an object previously detected by one of the plurality of nodes; and
transmitting a tracking message to at least one node of the plurality of nodes in response to determining the at least one signature corresponds to the object previously detected, the tracking message including the at least one signature for the object.

10. The method of claim 9, wherein the step of determining whether the at least one signature corresponds to an object previously detected comprises comparing the at least one signature to one or more signatures stored in memory, the one or more signatures corresponding to one or more objects previously detected.

11. The method of claim 10, further comprising steps of:
receiving a tracking message from a node in the system, the tracking message including at least one signature for an object detected by the node from which the tracking message was received; and
storing the at least one signature from the tracking message in memory.

12. The method of claim 9, wherein the step of detecting an object comprises detecting the object using at least one medium.

13. The method of claim 12, wherein the step of determining at least one signature comprises determining a signature for each medium used to track the object.

14. The method of claim 13, wherein the medium comprises one or more of infrared, acoustic and visual.

15. The method of claim 9, wherein the tracking message includes a location for the node of the plurality of nodes.

16. The method of claim 9, wherein the node of the plurality of nodes is a passive node operable to continue tracking of an object previously detected by an active node.

17. An apparatus comprising:
means for detecting an object in a monitoring area for a node of a plurality of nodes;
means for determining at least one signature for the object; and
means for transmitting a tracking message to at least one other node of the plurality of nodes, the tracking message including the at least one signature for the object.

18. The apparatus of claim 17, further comprising means for storing the at least one signature.

19. The apparatus of claim 17, wherein the means for detecting an object comprises means for detecting the object using at least one medium.

20. The apparatus of claim 19, wherein the means for determining comprises means for determining a signature for each medium used to track the object.

21. The apparatus of claim 20, wherein the medium comprises one or more of infrared, acoustic and visual.

22. The apparatus of claim 17, wherein the tracking message includes a location for the node of the plurality of nodes.

23. An apparatus comprising:
means for detecting an object in a monitoring area for a node of a plurality of nodes;
means for determining at least one signature for the object;
means for determining whether the at least one signature corresponds to an object previously detected by one of the plurality of nodes; and
means for transmitting a tracking message to at least one node of the plurality of nodes in response to determining the at least one signature corresponds to the object previously detected, the tracking message including the at least one signature for the object.

24. The apparatus of claim 23, wherein the means for determining whether the at least one signature corresponds to an object previously detected comprises means for comparing the at least one signature to one or more signatures stored in memory, the one or more signatures corresponding to one or more objects previously detected by a node of the system.

25. The apparatus of claim 24 further comprising:
means for receiving a tracking message from a node in the system, the tracking message including at least one signature for an object detected by the node from which the tracking message was received; and
means for storing the at least one signature from the tracking message in memory.

26. The apparatus of claim 23, wherein the means for detecting an object comprises means for detecting the object using at least one medium.

27. The apparatus of claim 26, wherein the means for determining at least one signature comprises means for determining a signature for each medium used to track the object.

28. The apparatus of 23, wherein the medium comprises one or more of infrared, acoustic and visual.

29. The apparatus of claim 23, wherein the tracking message includes a location for the node of the plurality of nodes.

30. A distributed surveillance system comprising:
a plurality of nodes including sensors for monitoring areas; and
a network connecting the plurality of nodes, wherein a node of the plurality of nodes is operable to detect an object in one of the monitoring areas and transmit a tracking message to other nodes of the plurality nodes via the network, wherein the tracking message identifies the detected object.

31. The system of claim 30, wherein the tracking message includes a location of the node.

32. The system of claim 30, wherein the tracking message includes at least one signature identifying the object.

33. The system of claim 32, wherein a second node of the plurality of nodes is operable to receive the at least one signature and store the at least one signature.

34. The system of claim 33, wherein the second node is further operable to detect an object in a second monitoring area of the monitoring areas and determine whether the object is the object detected by the one node of the plurality of nodes bases on the stored at least one signature.

35. A node in a distributed surveillance system comprising:
at least one sensor operable to detect an object;
a processor operable to determine a first signature for the object and generate a first tracking message including the first signature; and
a transmitter-operable to transmit the first tracking message to other nodes in the system.

36. The node of claim 35, further comprising:
a receiver operable to receive a second tracking message including a second signature from another node in the system; and
a memory operable to store the second signature.

37. The node of claim 36, wherein the processor is operable to compare the first signature with the second signature to determine whether a detected object corresponds to an object previously detected by the system and to generate a third tracking message for transmission to the other nodes in response to determining the object was previously detected by the system.
